(19) United States
(12) Patent Application Publication
(10) Pub. No.: US 2008/0239581 A1
(43) Pub. Date: Oct. 2, 2008

(54) Apparatus for determining contact of head slider and method of determining contact of head slider

(75) Inventors: Yoshiaki Ikai, Kawasaki (JP); Takahiro Imamura, Kawasaki (JP); Tohru Fujimaki, Kawasaki (JP); Toru Yokohata, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/892,452

(22) Filed: Aug. 23, 2007

(30) Foreign Application Priority Data
Oct. 13, 2006 (JP) 2006-280595

(51) Int. Cl. G11B 5/52

(52) U.S. Cl. 360/272

(57) ABSTRACT

An AC power source is connected to a write coil mounted on a head slider for determination of contact of a head slider with a storage medium. The AC power source outputs the alternating current having a specific frequency. A measuring circuit measures a sequence of indices for the alternating current supplied to the write coil. A component corresponding to the specific frequency is extracted from the sequence of the indices. This serves to eliminate components corresponding to frequencies other than the specific frequency, namely noise. A detecting circuit detects contact between the head slider and the storage medium based on a change in the amplitude of the sequence appearing at the specific frequency. The contact can thus reliably be detected between the head slider and the storage medium.

### BACKGROUND OF THE INVENTION

1. Field of the Invention

The present invention relates to a storage medium drive such as a hard disk drive, HDD. In particular, the invention relates to a storage medium drive comprising an actuator related to a write coil mounted on ahead slider. The actuator is designed to move the write coil in the direction perpendicular to the surface of the storage medium.

2. Description of the Prior Art

As described in Japanese Patent Application Publication No. 5-20635, for example, an actuator embedded in a head slider is well known. The actuator includes a heating wire. When current is supplied to the heating wire, the heating wire generates heat. Ahead element expands in response to the applied heat. The tip end of the head element, such as a write gap, is in this manner allowed to get closer to a magnetic recording disk.

When head sliders are incorporated in hard disk drives, respectively, the head sliders suffer from variation ranging from 2 nm to 3 nm in the flying height. A so-called zero calibration is executed to cancel the variation. An actuator is required to drive the head element during the flight of the head slider in the zero calibration. The head element is forced to gradually get closer to the rotating magnetic recording disk. Contact is detected between the head element and the magnetic recording disk. Protrusion amount is detected on the head element at the contact. The detected protrusion amount of the head element is utilized to determine the protrusion amount for reading or writing operation.

The zero calibration forces the head element to contact the tip end with the rotating magnetic recording disk. In this case, the contact is preferably established between the head slider and the magnetic recording disk as shorter duration as possible. If the head element is excessively kept in contact with the rotating magnetic recording disk, the head element gets damaged. One requires means for detecting contact between the head element and the magnetic recording disk in a short time and with a high accuracy.

### SUMMARY OF THE INVENTION

It is accordingly an object of the present invention to provide a storage medium drive and a method capable of detecting contact between a head element and a storage medium in a shorter time and with a higher accuracy. It is an object of the present invention to provide a determining apparatus greatly useful for realization of the storage medium drive.

According to a first aspect of the present invention, there is provided an apparatus for determining contact of a head slider, comprising: an AC power source connected to a write coil mounted on the head slider, the AC power source outputting the alternating current having a specific frequency; a measuring circuit measuring a sequence of indices for current supplied to the write coil; and a detecting circuit connected to the measuring circuit, the detecting circuit detecting contact between the head slider and a storage medium based on a change in the amplitude of the sequence appearing at the specific frequency.

For example, when the head slider is brought into contact with the storage medium around the write coil, the head slider is subjected to contact heat around the write coil. The contact heat causes a rapid rise in the temperature of the write coil. This causes an increase in the electric resistance of the write coil. A change in the electric resistance results in a change in the sequence of indices such as voltage values and current values resulting from the supply of the alternating current. The measuring circuit is designed to measure the change in the sequence of indices. In this case, a component corresponding to the specific frequency is extracted from the sequence of the indices. This serves to eliminate components corresponding to frequencies other than the specific frequency, namely noise. The change in the indices can be specified with a higher accuracy. A contact is thus reliably detected with a higher accuracy between the head slider and the storage medium. The apparatus may include, for example, a frequency analyzing circuit for extracting the component corresponding to the specific frequency. The frequency analyzing circuit may execute the Fourier transform on the sequence of the indices. Alternatively, the apparatus may include a bandpass filter circuit, for example. The bandpass filter circuit may be designed to allow the frequency of the alternating current to pass through.

The AC power source may keep the amplitude of the alternating current constant. A power amplifier IC may be employed as the AC power source for keeping the amplitude constant. In this case, the measuring circuit may measure the voltage appearing at the write coil based on the alternating current. The apparatus in this manner detects contact between the head slider and the storage medium based on the measurement of the voltage. Alternatively, the AC power source may keep the amplitude of the voltage, appearing at the AC power source, constant. In this case, the measuring circuit may measure the current value of the alternating current. Otherwise, the measuring circuit may measure the current value of the alternating current and the voltage value of the voltage appearing at the write coil based on the alternating current. In this case, the detecting circuit may calculate the sequence of the electrical resistance value based on the sequence of the current value and the sequence of the voltage value. The apparatus is in this manner allowed to detect contact between the head slider and the storage medium based on the change in the sequence.

The apparatus may further comprise an electrical resistive element connected to the write coil. The electrical resistive element establishes a bridge circuit in cooperation with the write coil. In this case, the detecting circuit may specify the change in the amplitude of the sequence based on the output from the bridge circuit. When the electric resistance changes in the write coil, an amplified change can be taken out from the bridge circuit. A contact is thus reliably detected between the head slider and the storage medium.

The apparatus can be incorporated in a storage medium drive, for example. In this case, the storage medium drive may comprise: storage medium; a head slider opposed to the storage medium; a write coil mounted on the head slider; an actuator related to the write coil, the actuator moving the write coil in a direction perpendicular to the surface of the storage medium; an AC power source connected to the write coil, the AC power source outputting the alternating current having a specific frequency; a measuring circuit measuring a sequence of indices for current supplied to the write coil; and a detecting circuit connected to the measuring circuit, the detecting circuit detecting contact between the head slider and the storage medium based on a change in the amplitude of the sequence appearing at the specific frequency.

The aforementioned apparatus may serve to provide a specific method of determining contact of a head slider. The method, for example, may comprise: applying the alternating current having a specific frequency to a write coil mounted on the head slider; measuring a sequence of indices for current supplied to the write coil; and detecting a change in the amplitude of the sequence appearing at the specific frequency while the write coil gets closer to a storage medium.

According to a second aspect of the present invention, there is provided an apparatus for determining contact of a head slider, comprising: an AC power source connected to a heater mounted the head slider, the AC power source outputting the alternating current having a specific frequency; a measuring circuit measuring a sequence of indices for current supplied to the heater; and a detecting circuit connected to the measuring circuit, the detecting circuit detecting contact between the head slider and a storage medium based on a change in the amplitude of the sequence appearing at the specific frequency.

For example, when the head slider is brought into contact with the storage medium around the heater, the head slider is subjected to contact heat around the heater. The contact heat causes a rapid rise in the temperature of the heater. This causes an increase in the electric resistance of the heater. A change in the electric resistance results in a change in the sequence of indices such as voltage values and current values resulting from the alternating current. The measuring circuit is designed to measure the change in the sequence of indices. In this case, a component corresponding to a specific frequency is extracted from the sequence of the indices. This serves to eliminate components corresponding to frequencies other than the specific frequency, namely noise. The change in the indices can be specified with a higher accuracy. A contact is thus reliably detected with a higher accuracy between the head slider and the storage medium. The heater may be mounted on the head slider around the write coil, for example. When the amplitude of the alternating current increases in the heater, the write coil gets closer to the storage medium. The apparatus may include, for example, a frequency analyzing circuit for extracting the component corresponding to the specific frequency. The frequency analyzing circuit may execute the Fourier transform on the sequence of the indices. Alternatively, the apparatus may include a bandpass filter circuit, for example. The bandpass filter circuit may be designed to allow the frequency of the alternating current to pass through.

The AC power source may keep the amplitude of the alternating current constant. A power amplifier IC may be employed as the AC power source for keeping the amplitude constant. In this case, the measuring circuit may measure the voltage appearing at the heater based on the alternating current. The apparatus in this manner detects contact between the head slider and the storage medium based on the measurement of the voltage. Alternatively, the AC power source may keep the amplitude of the voltage, appearing at the AC power source, constant. In this case, the measuring circuit may measure the current value of the alternating current. Otherwise, the measuring circuit may measure the current value of the alternating current and the voltage value of the voltage appearing at the heater based on the alternating current. In this case, the detecting circuit may calculate the sequence of the electrical resistance value based on the sequence of the current value and the sequence of the voltage value. The apparatus is in this manner allowed to detect contact between the head slider and the storage medium based on the change in the sequence.

The apparatus may further comprise an electrical resistive element connected to the heater. The electrical resistive element establishes a bridge circuit in cooperation with the heater. In this case, the detecting circuit may specify the change in the amplitude of the sequence based on the output from the bridge circuit. When the electric resistance changes in the heater, an amplified change can be taken out from the bridge circuit. A contact is thus reliably detected between the head slider and the storage medium.

The apparatus can be incorporated in a storage medium drive, for example. In this case, the storage medium drive may comprise: a storage medium; a head slider opposed to the storage medium; a write coil mounted on the head slider; a heater mounted on the head slider, the heater related to the write coil; an AC power source connected to the heater, the AC power source outputting the alternating current having a specific frequency; a measuring circuit measuring a sequence of indices for current supplied to the heater; and a detecting circuit connected to the measuring circuit, the detecting circuit detecting contact between the head slider and the storage medium based on a change in the amplitude of the sequence appearing at the specific frequency.

The aforementioned apparatus may serve to provide a specific method of determining contact of a head slider. The method, for example, may comprise: applying the alternating current having a specific frequency to a heater mounted on the head slider, the heater related to a write coil; measuring a sequence of indices for current supplied to the heater; and detecting a change in the amplitude of the sequence appearing at the specific frequency while the write coil gets closer to a storage medium.

### BRIEF DESCRIPTION OF THE DRAWINGS

The above and other objects, features and advantages of the present invention will become apparent from the following description of the preferred embodiments in conjunction with the accompanying drawings, wherein:

FIG. 1 is a plan view schematically illustrating the structure of a hard disk drive, HDD, as an example of a storage medium drive according to an embodiment of the present invention;

FIG. 2 is an enlarged perspective view schematically illustrating a flexure incorporated in the hard disk drive;

FIG. 3 is an enlarged perspective view schematically illustrating a flying head slider mounted on the flexure;

FIG. 4 is a side view of the front end of a head suspension illustrating the flying head slider during flight;

FIG. 5 is a side view of the front end of the head suspension illustrating the flying head slider during flight with a piezoelectric element active;

FIG. 6 is an enlarged front view of an electromagnetic transducer;

FIG. 7 is a sectional view taken along the line 7-7 in FIG. 6;

FIG. 8 is a block diagram schematically illustrating a determining apparatus according to a first embodiment of the present invention;

FIG. 9 is a flowchart schematically illustrating the procedures of a controller circuit;

FIG. 10 is a graph illustrating the correlation between the shrinkage amount of the piezoelectric element, the current value of the alternating current, the voltage value of the voltage resulting from the alternating current and the amplitude value of the voltage when contact is to be determined;

FIG. 11 is a graph illustrating the voltage waveform of the alternating voltage and the voltage waveform of the direct voltage;

FIG. 12 is a graph illustrating frequency spectrum of noise;

FIG. 13 is a graph illustrating the result of Fourier transform;

FIG. 14 is a graph illustrating the change in the amplitude subjected to the Fourier transform and the change in the voltage value of the direct voltage subjected to the Fourier transform;

FIG. 15 is a block diagram schematically illustrating a determining apparatus according to a modification of the first embodiment;

FIG. 16 is a graph illustrating the voltage waveform of the alternating voltage and the voltage waveform of the direct voltage;

FIG. 17 is a graph illustrating frequency characteristics of a bandpass filter circuit;

FIG. 18 is a graph illustrating the change in the amplitude subjected to the operation of the bandpass filter circuit and the change in the voltage value of the direct voltage;

FIG. 19 is a block diagram schematically illustrating a determining apparatus according to a second embodiment of the present invention;

FIG. 20 is a block diagram schematically illustrating a determining apparatus according to a third embodiment of the present invention;

FIG. 21 is a graph illustrating the correlation between the shrinkage amount of the piezoelectric element, the current value of the alternating current, the voltage value of the voltage resulting from the alternating current and the electrical resistance value of a thin film coil pattern when contact is to be determined;

FIG. 22 is a block diagram schematically illustrating a determining apparatus according to a fourth embodiment of the present invention;

FIG. 23 is a graph illustrating the correlation between the shrinkage amount of the piezoelectric element, the current value of the alternating current, the output from a bridge circuit and the amplitude value when contact is to be determined;

FIG. 24 is a sectional view, corresponding to FIG. 7, schematically illustrating a heater, namely a heating wire embedded in the flying head slider;

FIG. 25 is an enlarged side view of the flying head slider schematically illustrating a thin film magnetic head element when electric power is supplied to the heating wire;

FIG. 26 is a block diagram schematically illustrating the determining apparatus according to the first embodiment of the present invention connected to the heating wire, that is, the heat actuator;

FIG. 27 is a graph illustrating the correlation between the displacement amount of the actuator, the current value of the alternating current, the voltage value resulting from the alternating current and the amplitude value of the voltage when contact is to be determined;

FIG. 28 is a block diagram schematically illustrating the determining apparatus according to the modification of the first embodiment connected to the heating wire, that is, the heat actuator;

FIG. 29 is a block diagram schematically illustrating the determining apparatus according to the second embodiment of the present invention connected to the heating wire, that is, the heat actuator;

FIG. 30 is a block diagram schematically illustrating the determining apparatus according to the third embodiment of the present invention connected to the heating wire, that is, the heat actuator;

FIG. 31 is a graph illustrating the correlation between the displacement amount of the actuator, the current value of the alternating current, the voltage value resulting from the alternating current and the electrical resistance value of the heater when contact is to be determined;

FIG. 32 is a block diagram schematically illustrating the determining apparatus according to the fourth embodiment of the present invention connected to the heating wire, that is, the heat actuator;

FIG. 33 is a graph illustrating the correlation between the displacement amount of the actuator, the current value of the alternating current, the output from a bridge circuit and the amplitude value when contact is to be determined; and

FIG. 34 is a graph schematically illustrating a method of controlling the shrinkage amount of the piezoelectric element and the displacement amount of the actuator.

### DESCRIPTION OF THE PREFERRED EMBODIMENTS

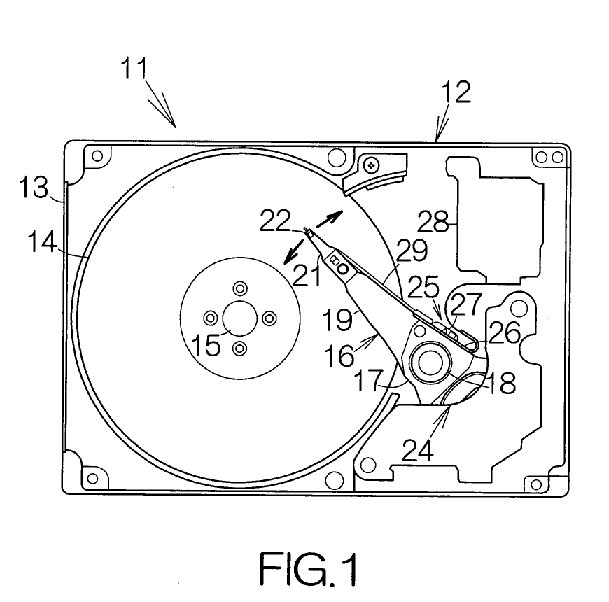

FIG. 1 schematically illustrates the inner structure of a hard disk drive, HDD, 11 as an example of a storage medium drive or a storage device according to the present invention. The hard disk drive 11 includes an enclosure 12. The enclosure 12 includes a box-shaped base 13 and an enclosure cover, not shown. The base 13 defines an inner space in the form of a flat parallelepiped, for example. The base 13 may be made of a metallic material such as aluminum, for example. Molding process may be employed to form the base 13. The enclosure cover is coupled to the base 13 to close the opening of the base 13. An inner space is defined between the base 13 and the enclosure cover. Pressing process may be employed to form the enclosure cover out of a plate material, for example.

At least one magnetic recording disk 14 as a storage medium is enclosed in the enclosure 12. The magnetic recording disk or disks 14 are mounted on the driving shaft of a spindle motor 15. The spindle motor 15 drives the magnetic recording disk or disks 14 at a higher revolution speed such as 5,400 rpm, 7,200 rpm, 10,000 rpm, 15,000 rpm, or the like.

A carriage 16 is also enclosed in the enclosure 12. The carriage 16 includes a carriage block 17. The carriage block 17 is supported on a vertical support shaft 18 for relative rotation. Carriage arms 19 are defined in the carriage block 17. The carriage arms 19 are designed to extend in the horizontal direction from the vertical support shaft 18. The carriage block 17 may be made of aluminum, for example. Extrusion molding process may be employed to form the carriage block 17, for example.

A head suspension 21 is attached to the front or tip end of the individual carriage arm 19. The head suspension 21 is designed to extend forward from the carriage arm 19. A flexure is attached to the tip end of the individual head suspension 21. The flexure will be described later in detail. A so-called gimbal spring is defined in the flexure. The gimbal spring allows a flying head slider 22 to change its attitude relative to the head suspension 21. A magnetic head or electromagnetic transducer is mounted on the flying head slider 22 as described later in detail.

When the magnetic recording disk 14 rotates, the flying head slider 22 is allowed to receive an airflow generated along the rotating magnetic recording disk 14. The airflow serves to generate a positive pressure or a lift as well as a negative pressure on the flying head slider 22. The flying head slider 22 is thus allowed to keep flying above the surface of the magnetic recording disk 14 during the rotation of the magnetic recording disk 14 at a higher stability established by the balance between the urging force of the head suspension 21 and the combination of the lift and the negative pressure.

When the carriage 16 swings around the vertical support shaft 18 during the flight of the flying head slider 22, the flying head slider 22 is allowed to move along the radial direction of the magnetic recording disk 14. The electromagnetic transducer on the flying head slider 22 is thus allowed to cross the data zone defined between the innermost and outermost recording tracks. The electromagnetic transducer on the flying head slider 22 is positioned right above a target recording track on the magnetic recording disk 14.

A power source or voice coil motor, VCM, 24 is coupled to the carriage block 17. The voice coil motor 24 serves to drive the carriage block 17 around the vertical support shaft 18. The rotation of the carriage block 17 allows the carriage arms 19 and the head suspensions 21 to swing.

As is apparent from FIG. 1, a flexible printed circuit board unit 25 is located on the carriage block 17. The flexible printed circuit board unit 25 includes a head IC (integrated circuit) 27 mounted on a flexible printed wiring board 26. The head IC 27 is designed to supply the read element of the electromagnetic transducer with a sensing current when the magnetic bit data is to be read. The head IC 27 is also designed to supply the write element of the electromagnetic transducer with a writing current when the magnetic bit data is to be written. A small-sized printed circuit board 28 is placed in the inner space of the enclosure 12. A printed circuit board, not shown, is attached to the back surface of the bottom plate of the base 13. The small-sized printed circuit board 28 and the printed circuit board are designed to supply the head IC 27 of the flexible printed circuit board unit 25 with the sensing current and the writing current. A flexible printed wiring board 29 is utilized to supply the sensing current and writing current. The flexible printed wiring board 29 extends from the individual flexure. The flexible printed wiring board 29 is connected to the flexible printed circuit board unit 25.

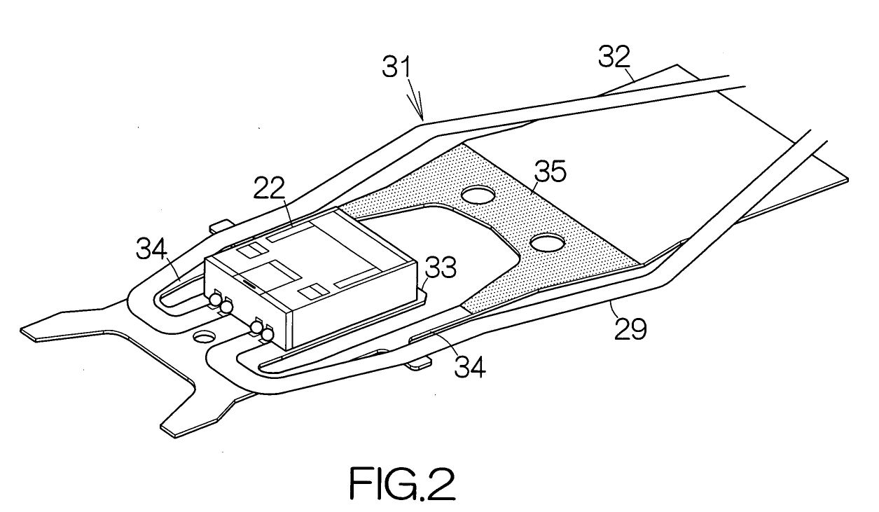

As is apparent from FIG. 2, a flexure 31 includes a fixation plate 32. The fixation plate 32 is fixed to the head suspension 21. A support plate 33 is connected to the fixation plate 32 for supporting the flying head slider 22. The fixation plate 32 defines a surface receiving the flying head slider 22. A so-called gimbal spring 34 is defined between the support plate 33 and the fixation plate 32. The gimbal spring 34 allows the support plate 33 or the flying head slider 22 to change the attitude relative to the fixation plate 32. The fixation plate 32, the support plate 33 and the gimbal spring 34 may be made of a leaf spring sheet. The leaf spring sheet may be made of a stainless steel sheet having a constant thickness, for example.

The flexible printed wiring board 29 includes an insulating base film, for example. The insulating base film is partially attached to the surface of the support plate 33 and the fixation plate 32. An electrically-conductive layer is formed on the surface of the insulating base film. The electrically-conductive layer includes a wiring pattern. The wiring pattern is covered with a protection layer. The electrically-conductive layer may be made of an electrically-conductive material such as copper. The insulating base film and the protection layer may be made of a resin material such as polyimide resin. The wiring pattern is connected to the flying head slider 22 at the front end of the flexible printed wiring board 29. The wiring pattern is connected to a wiring pattern extending on the flexible printed wiring board 26 at the rear end of the flexible printed wiring board 29. The flying head slider 22 is thus connected to the head IC 27.

A piezoelectric element 35 is coupled to the fixation plate 32. The piezoelectric element 35 includes a piezoelectric ceramic thin film extending along the surface of the fixation plate 32. The piezoelectric ceramic thin film may be made of a piezoelectric material such as PNN-PT-PZ, for example. An electrode is overlaid all over the surface of the piezoelectric ceramic thin film. The electrode may be made of an electrically-conductive material such as copper. The piezoelectric ceramic thin film is thus interposed between the fixation plate 32 and the electrode.

When a driving voltage is applied to the piezoelectric ceramic thin film, for example, between the fixation plate 32 and the electrode, a potential difference is generated between the fixation plate 32 and the electrode. Polarization is caused in the piezoelectric ceramic thin film according to the direction of the voltage established between the fixation plate 32 and the electrode. The voltage is further applied in the direction of the polarization. The piezoelectric ceramic thin film correspondingly expands in the direction perpendicular to the surface of the fixation plate 32. The piezoelectric ceramic thin film shrinks in the longitudinal direction along the direction of the airflow. The shrinkage of the piezoelectric ceramic thin film causes the fixation plate 32 to bend. The flying head slider 22 gets closer to the magnetic recording disk 14 in response to increase in the bending amount, as described later. The piezoelectric ceramic thin film and the fixation plate 32 in combination establish a so-called unimorph piezoelectric actuator. Voltage is applied to the electrode from the wiring pattern on the flexible printed wiring board 29, for example.

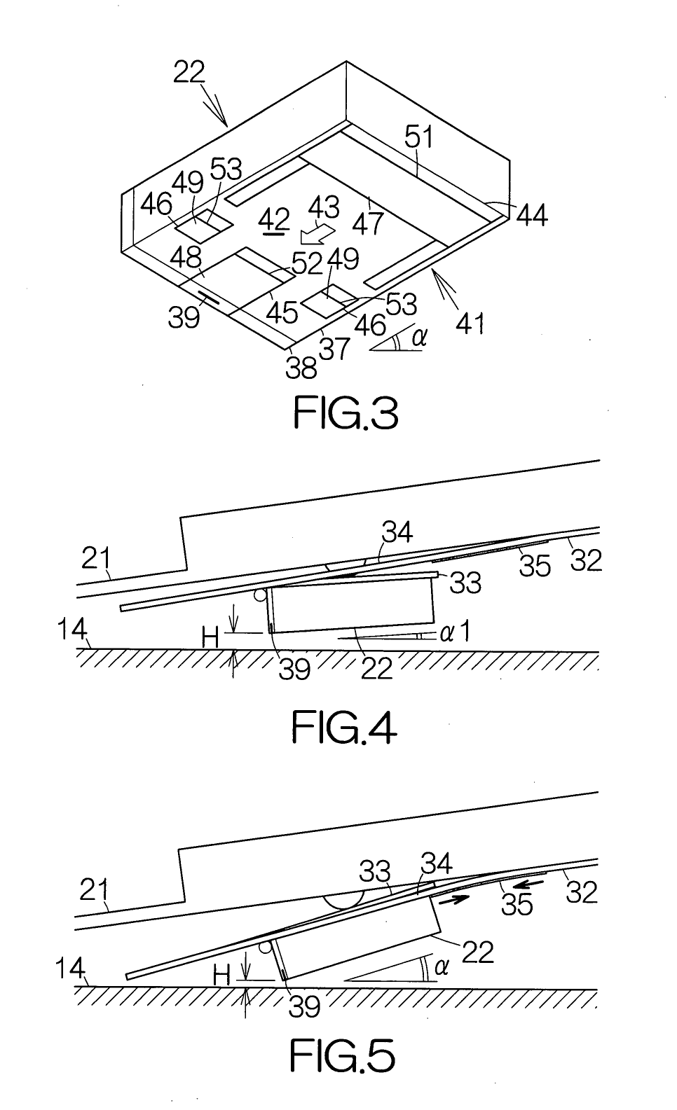

FIG. 3 illustrates a specific example of the flying head slider 22. The flying head slider 22 includes a slider body 37 in the form of a flat parallelepiped, for example. A head protection film 38 is overlaid on the outflow or trailing end of the slider body 37. The aforementioned magnetic head or electromagnetic transducer 39 is embedded in the head protection film 38. The electromagnetic transducer 39 will be described in detail.

The slider body 37 may be made of a hard non-magnetic material such as Al₂O₃—TiC. The head protection film 38 may be made of a relatively soft insulating non-magnetic material such as Al₂O₃ (alumina). A medium-opposed surface or bottom surface 41 is defined over the slider body 37 so as to face the magnetic recording disk 14 at a distance. A flat base surface 42 as a reference surface is defined on the bottom surface 41. When the magnetic recording disk 14 rotates, airflow 43 flows along the bottom surface 41 from the front end of the slider body 37 toward the rear end of the slider body 37.

A front rail 44 is formed on the bottom surface 41. The front rail 44 stands upright from the base surface 42 at a position near the inflow end of the base surface 42. The front rail 44 extends along the inflow end of the base surface 42 in the lateral direction of the slider body 37. A rear rail 45 is likewise formed on the bottom surface 41. The rear rail 45 stands upright from the base surface 42 at a position near the outflow end of the base surface 42. The rear rail 45 is located on the intermediate position in the lateral direction of the slider body 37.

A pair of auxiliary rear rails 46, 46 is further formed on the bottom surface 41. The auxiliary rear rails 46, 46 stand upright from the base surface 42 at positions near the outflow end of the base surface 42. The auxiliary rear rails 46, 46 are respectively located along the sides of the base surface 42. The auxiliary rear rails 46, 46 are thus spaced from each other in the lateral direction of the slider body 37. The rear rail 45 is located in a spaced between the auxiliary rear rails 46, 46.

Air bearing surfaces, ABS, 47, 48, 49 are respectively defined on the top surfaces of the front rail 44, the rear rail 45 and the auxiliary rear rails 46. Steps 51, 52, 53 are formed to connect the inflow ends of the air bearing surfaces 47, 48, 49 to the top surfaces of the rails 44, 45, 46, respectively. The bottom surface 41 receives the airflow 43 generated along the rotating magnetic recording disk 14. The steps 51, 52, 53 serve to generate a relatively large positive pressure or lift at the air bearing surfaces 47, 48, 49. Moreover, a relatively large negative pressure is generated behind the front rail 44. The flying head slider 22 is thus allowed to take a flying attitude based on the balance between the lift and the negative pressure.

A protection film, not shown, is formed on the surface of the slider body 37 at each of the air bearing surfaces 47, 48, 49, for example. The aforementioned electromagnetic transducer 39 is designed to expose a read gap and a write gap at the surface of the head protection film 38 at a position downstream of the air bearing surface 48. The protection film extends over the read gap and the write gap of the electromagnetic transducer 39. The protection film may be made of diamond-like-carbon (DLC), for example. It should be noted that the flying head slider 22 may take any shape or form different from the described one.

As shown in FIG. 4, when voltage is not applied to the piezoelectric element 35, the piezoelectric element 35 maximally expands along the surface of the fixation plate 32. The fixation plate 32 thus stays flat. In this case, if the flying head slider 22 is opposed to the rotating magnetic recording disk 14, the flying head slider 22 is allowed to fly in an attitude of a predetermined pitch angle α1. The flying height H is set at the maximum height. When voltage is applied to the piezoelectric element 35, the piezoelectric element 35 shrinks along the surface of the fixation plate 32, as shown in FIG. 5. The fixation plate 32 bends in this case. The pitch angle α thus increases. The outflow end of the flying head slider 22 is driven toward the surface of the magnetic recording disk 14 in response to increase in the pitch angle α. The flying head slider 22 thus enjoys a reduced flying height H. The electromagnetic transducer 39 gets closer to the magnetic recording disk 14. The shrinkage amount of the piezoelectric element 35 is in this manner utilized to set the flying height H of the flying head slider 22 at a target flying height Hs.

FIG. 6 illustrates the electromagnetic transducer 39 in detail. The electromagnetic transducer 39 includes a CPP structure read head element 56 and a thin film magnetic head element or write head element 57, for example. The read head element 56 is designed to detect variation in the electric resistance in response to a magnetic field applied from the magnetic recording disk 14, thereby discriminating magnetic bit data on the magnetic recording disk 14 in a conventional manner. The write head element 57 is designed to utilize a magnetic field induced at an electrically-conductive coil pattern, not shown, so as to write magnetic bit data onto the magnetic recording disk 14, for example, in a conventional manner. The read head element 56 and the write head element 57 are interposed between an Al₂O₃ film 58 and an Al₂O₃ film 59. The Al₂O₃ film 58 serves as an overcoat film, namely the upper half layer of the aforementioned head protection film 38. The Al₂O₃ film 59 likewise serves as an undercoat film, namely the lower half layer of the head protection film 38.

The read head element 56 includes a magnetoresistive film 61 such as a spin valve film or a tunnel-junction film. The magnetoresistive film 61 is interposed between an upper electrode 62 and a lower electrode 63. The upper and lower electrodes 62, 63 respectively allow the front ends, exposed at the surface of the head protection film 38, to contact with the upper and lower boundaries of the magnetoresistive film 61. The sensing current is supplied to the magnetoresistive film 61 through the upper and lower electrodes 62, 63. The upper and lower electrodes 62, 63 may have not only electrical conductivity but also soft magnetism. If the upper and lower electrodes 62, 63 are made of a soft magnetic material having electrical conductivity, such as permalloy, NiFe alloy, the upper and lower electrodes 62, 63 also serve as upper and lower shielding layers of the read head element 56. The upper and lower electrodes 62, 63 thus define a read gap.

The write head element 57 includes an upper magnetic pole layer 64 and a lower magnetic pole layer 65. The upper magnetic pole layer 64 has the front end exposed at the surface of the head protection film 38. The front end of the upper magnetic pole layer 64 is opposed to the magnetic recording disk 14. The lower magnetic pole layer 65 likewise has the front end exposed at the surface of the head protection film 38. The front end of the lower magnetic pole layer 65 is opposed to the magnetic recording disk 14. The upper and lower magnetic pole layers 64, 65 may be made of FeN, NiFe, or the like, for example. The upper and lower magnetic pole layers 64, 65 in combination establish the magnetic core of the write head element 57.

A non-magnetic gap layer 66 is interposed between the upper and lower magnetic pole layers 64, 65. The non-magnetic gap layer 66 is made of Al₂O₃, for example. When a magnetic field is generated at a thin film coil pattern, the magnetic flux exchanged between the upper and lower magnetic pole layers 64, 65. The non-magnetic gap layer 66 serves to leak the magnetic flux out of the head protection film 38 toward the magnetic recording disk 14. The leaked magnetic flux forms a magnetic field for recordation. The upper and lower magnetic pole layers 64, 65 in this manner define the write gap.

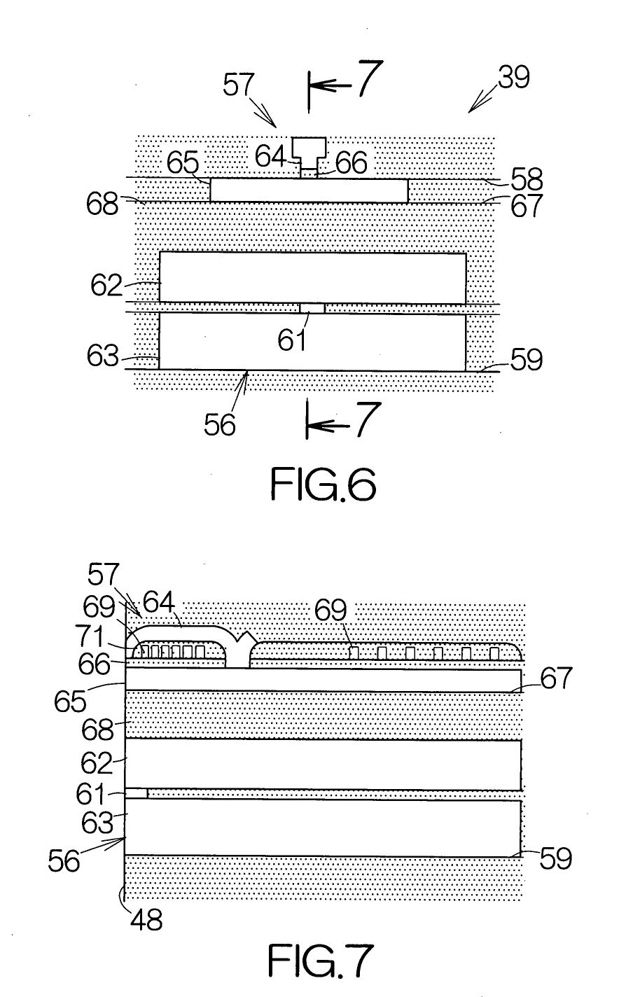

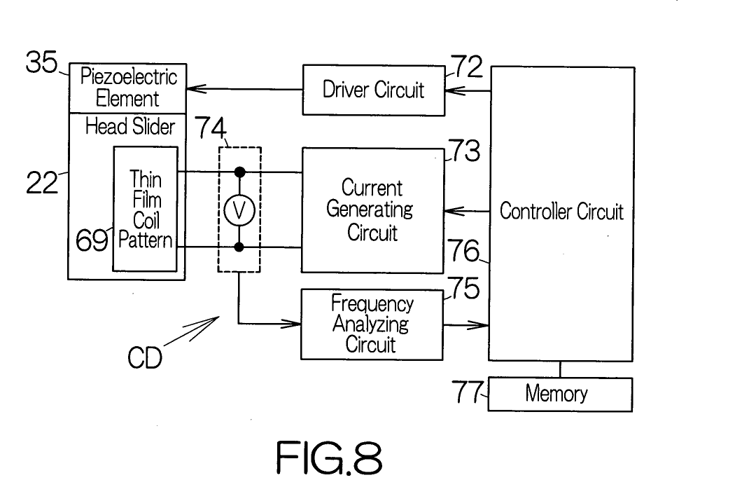

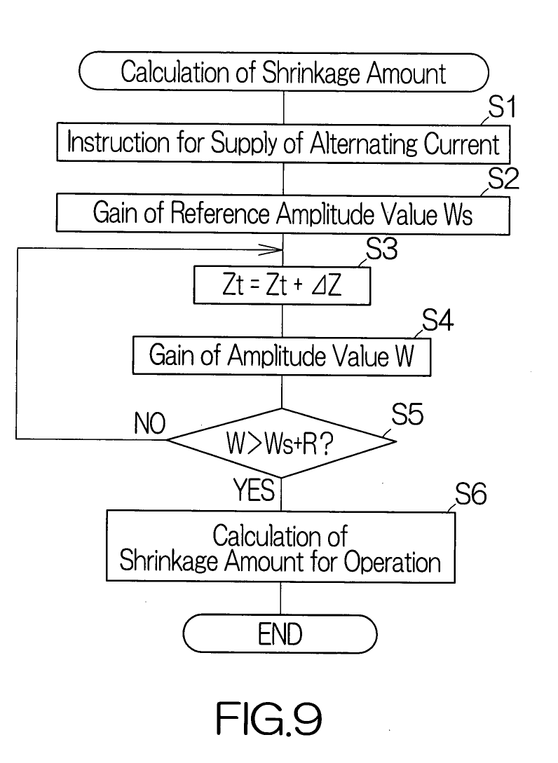

Referring also to FIG. 7, the lower magnetic pole layer 65 extends along a reference plane 59 above the upper electrode 62. The reference plane 67 is defined on the surface of a non-magnetic layer 68 made of Al₂O₃. The non-magnetic layer 68 may be overlaid on the upper electrode 62 by a constant thickness. The non-magnetic layer 67 enables magnetic isolation between the upper electrode 62 and the lower magnetic pole layer 65.

The non-magnetic gap layer 66 extends on the lower magnetic pole layer 65 at a constant thickness. The aforementioned thin film coil pattern 69 is located on the non-magnetic gap layer 66. The thin film coil pattern 69 takes the swirly pattern along a plane. The thin film coil pattern 69 is embedded within an insulating layer 71 on the non-magnetic gap layer 66. The aforementioned upper magnetic pole layer 64 is formed on the surface of the insulating layer 71. A magnetic connection is established between the upper magnetic pole layer 64 and the lower magnetic pole layer 65 at the center of the thin film coil pattern 69. Magnetic flux runs through the upper and lower magnetic pole layers 64, 65 in response to supply of electric current to the thin film coil pattern 69.

As shown in FIG. 8, a driver circuit 72 is connected to the piezoelectric actuator or piezoelectric element 35. The driver circuit 72 is designed to apply voltage to the piezoelectric element 35. The magnitude of the applied voltage determines the deformation amount of the piezoelectric element 35.

A determining apparatus CD according to a first embodiment of the present invention is connected to the thin film coil pattern 69. The determining apparatus CD includes a current generating circuit 73 connected to the thin film coil pattern 69. The current generating circuit 73 is designed to output an alternating current having a specific frequency f [Hz] to the thin film coil pattern 69. Specifically, the current generating circuit 73 serves as an AC power source of the present invention. The specific frequency f may be set equal to or higher than 10 [kHz] approximately, for example. The frequency f is preferably set equal to or higher than 1 [MHz] approximately. Here, the current generating circuit 73 keeps the amplitude of the alternating current constant. Specifically, the current waveform has a constant amplitude. A power amplifier IC may be employed for the current generating circuit 73.

A voltage measuring circuit 74 of the determining apparatus CD is connected to the thin film coil pattern 69. The voltage measuring circuit 74 measures the voltage value of the voltage appearing at the thin film coil pattern 69 based on the alternating current supplied to the thin film coil pattern 69. The voltage measuring circuit 74 constantly measures the voltage values so that the voltage measuring circuit 74 obtains the voltage waveform. The voltage values correspond to a sequence of indices for current according to the present invention.

A frequency analyzing circuit 75 is connected to the voltage measuring circuit 74. The frequency analyzing circuit 75 subjects the voltage waveform to Fourier transform in every specific period. A spectrum is thus detected in the frequency analyzing circuit 75. The spectrum indicates amplitude of the voltage at every frequency. The frequency analyzing circuit 75 extracts from the spectrum the amplitude of a component corresponding to the aforementioned frequency f. The frequency analyzing circuit 75 outputs an amplitude value signal for the specific period. The amplitude value signal specifies the value of the extracted amplitude.

A controller circuit 76 is connected to the frequency analyzing circuit 75. The controller circuit 76 receives the amplitude value signal. The controller circuit 76 monitors change in the amplitude based on the amplitude value signal. Here, the frequency analyzing circuit 75 and the controller circuit 76 in combination corresponds to a detecting circuit according to the present invention. A microprocessor may be utilized as the controller circuit 76, for example.

The aforementioned driver circuit 72 and the current generating circuit 73 are connected to the controller circuit 76. An instruction signal is supplied to the driver circuit 72 from the controller circuit 76. The driver circuit 72 determines a voltage value of the voltage applied to the piezoelectric element 35 based on the instruction signal. The current generating circuit 73 switches on and off the output of the alternating current based on a control signal supplied from the controller circuit 76.

A memory 77 is connected to the controller circuit 76. Predetermined software programs and data are stored in the memory 77, for example. The controller circuit 76 executes specified processes based on the software programs and data. The driver circuit 72, the current generating circuit 73, the voltage measuring circuit 74, the frequency analyzing circuit 75, the controller circuit 76 and the memory 77 may be mounted on the flexible printed wiring board 26, for example.

Next, a brief description will be made below on the procedures of the controller circuit 76 for setting the target flying height Hs. As shown in the flowchart of FIG. 9, the controller circuit 76 instructs supply of an alternating current at step S1. In this case, the controller circuit 76 supplies a control signal to the current generating circuit 73. The current generating circuit 73 outputs an alternating current in response to the reception of the control signal. The alternating current is supplied to the thin film coil pattern 69. The frequency of the alternating current is set at f[Hz]. The amplitude of the alternating current is kept constant regardless of a change in the electric resistance of the thin film coil pattern 69.

The controller circuit 76 obtains a reference amplitude value Ws of the alternating current at step S2. The controller circuit 76 receives the amplitude value signal from the frequency analyzing circuit 75. The voltage measuring circuit 74 measures the value of the voltage appearing at the thin film coil pattern 69 based on the alternating current. The voltage measuring circuit 74 outputs voltage waveform. The voltage waveform is supplied to the frequency analyzing circuit 75. The frequency analyzing circuit 75 subjects the voltage waveform to Fourier transform. The Fourier transform of the voltage waveform allows extraction of the amplitude of the component corresponding to the specific frequency f. In this case, the components corresponding to frequencies other than the specific frequency f, namely noise, are eliminated, so that the amplitude of the voltage can be specified with high accuracy. The reference amplitude value Ws may temporarily be stored in a cache memory, for example.

Subsequently, the controller circuit 76 serves to increase the shrinkage amount Zt of the piezoelectric element 35 by a predetermined amount ΔZ to shrink the piezoelectric element 35. The flying height H of the flying head slider 22 decreases in response to the shrinkage of the piezoelectric element 35. Voltage is applied to the piezoelectric element 35 from the driver circuit 72 for the shrinkage of the piezoelectric element 35. The controller circuit 76 supplies an instruction signal to the driver circuit 72 for the application of the voltage. The voltage value of the applied voltage is specified in the instruction signal. An actual measurement may be conducted to reveal the relationship between the voltage value and the deformation amount of the piezoelectric element 35. The predetermined amount ΔZ may be set at l[nm], for example. The shrinkage amount Zt of the piezoelectric element 35 may temporarily be stored in the cache memory, for example.

When the flying height H has decreased, the controller circuit 76 receives the amplitude value signal at step S4. The controller circuit 76 obtains the amplitude value W of the voltage appearing at the thin film coil pattern 69 in response to the supply of the alternating current. The amplitude value W is compared with the aforementioned reference amplitude value Ws at step S5. Change is in this manner observed in the amplitude value W. In this case, a margin R may be set for the reference amplitude value Ws. As will be described later, the margin R is useful to avoid an erroneous detection of the contact. If the amplitude value W gets larger than a reference value (Ws+R), the controller circuit 76 determines that the flying head slider 22 has just contacted with the magnetic recording disk 14. In this case, the flying height H of the flying head slider 22 is determined to be zero (H=0). The shrinkage amount Zs of the piezoelectric element 35 is determined when the flying head slider 22 has contacted with the magnetic recording disk 14. As the shrinkage amount Zt of the piezoelectric element 35 decreases from the shrinkage amount Zs at the contact, the flying head slider 22 gets distanced from the magnetic recording disk 14.

The controller circuit 76 calculates the shrinkage amount for the reading or writing operation based on the shrinkage amount Zs at the contact and the target flying height Hs(=6 [nm], e.g.) at step S6. The controller circuit 76 calculates the voltage value of the voltage output from the driver circuit 72 based on the calculated shrinkage amount. The calculated voltage value is stored in the memory 77. The flying head slider 22 thus flies at the target flying height Hs above the surface of the magnetic recording disk 14 with high accuracy. It should be noted that the shrinkage amount Zs may be stored in the memory 77 in place of the calculated voltage value. In this case, the shrinkage amount of the piezoelectric element 35 is calculated based on the shrinkage amount Zs at the contact and the target flying height Hs just prior to the reading or writing operation.

If the amplitude value W is smaller than the reference value (Ws+R) at step S5, the processing of the controller circuit 76 returns to step S3. The controller circuit 76 serves to increase the shrinkage amount Zt of the piezoelectric element 35 by a predetermined amount ΔZ. Specifically, the shrinkage amount Zt of the piezoelectric element 35 is thus stepwise increased until contact is discovered between the flying head slider 22 and the magnetic recording disk 14. The shrinkage amount Zt of the piezoelectric element 35 may temporarily be stored in the cache memory, for example, every time when the shrinkage amount Zt increases.

Now, assume that a reference value H(=0) of the flying height is determined. The reference value H(=0) may be determined every time when the hard disk drive 11 is switched on, for example. Alternatively, the determination of the reference value H(=0) may be executed at predetermined intervals. First of all, the shrinkage amount Zt of the piezoelectric element 35 is set at zero [nm]. Specifically, the driver circuit 72 suspends supply of the voltage.

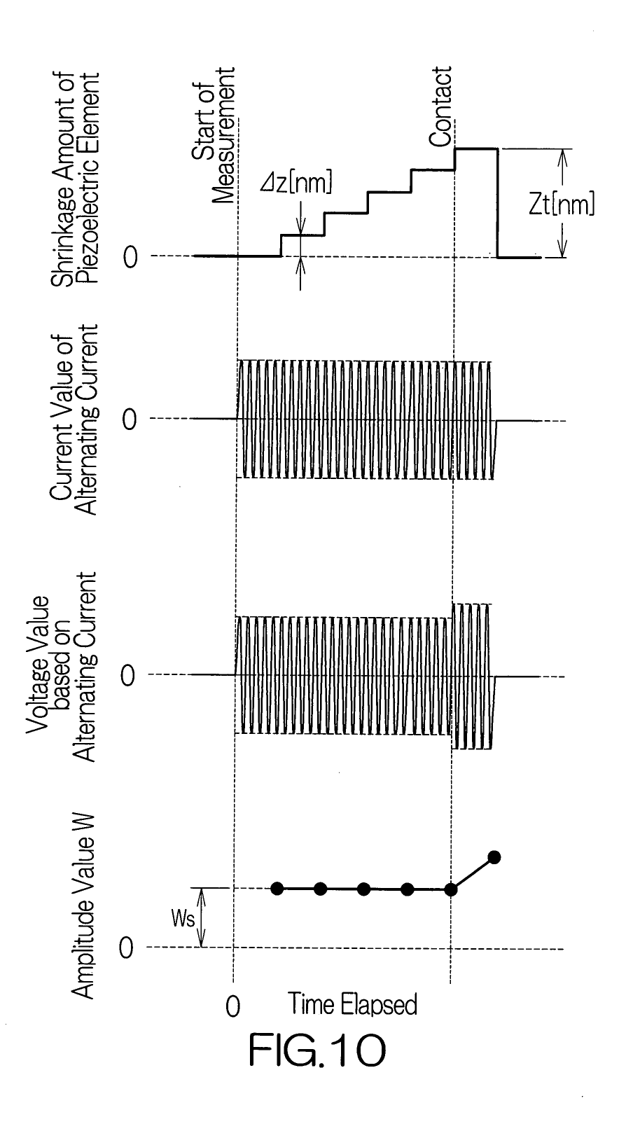

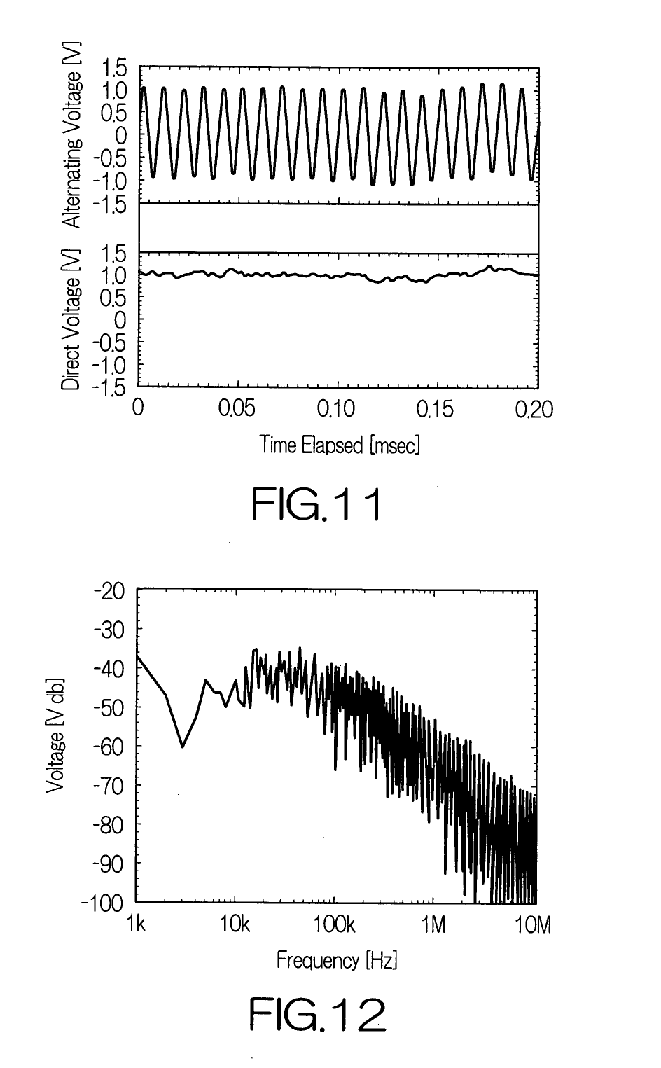

Subsequently, the controller circuit 76 outputs the instructions for the supply of the alternating current in the same manner as described above. The alternating current is supplied to the thin film coil pattern 69 from the current generating circuit 73. As shown in FIG. 10, the alternating current keeps a constant amplitude. The controller circuit 76 receives the amplitude value signal from the frequency analyzing circuit 75 in response to the supply of the alternating current.

The thin film coil pattern 69 generates heat in response to the supply of the alternating current. The generated heat serves to keep the thin film coil pattern 69 at a predetermined temperature. The thin film coil pattern 69 is thus allowed to enjoy a constant electrical resistance. As long as the temperature of the thin film coil pattern 69 is kept constant, a constant amplitude value, namely the reference amplitude value Ws is observed in the amplitude value signal. The controller circuit 76 stepwise increases the shrinkage amount Zt of the piezoelectric element 35. After the shrinkage amount Zt has increased by the predetermined amount ΔZ, the shrinkage amount Zt is kept constant. The duration of the invariable shrinkage amount Zt may be set based on the period of the Fourier transform, for example. The driver circuit 72 raises the voltage value of the applied voltage based on the instruction signal supplied from the controller circuit 76.

When the flying head slider 22 is brought into contact with the magnetic recording disk 14, the flying head slider 22 suffers from the contact heat. The temperature of the thin film coil pattern 69 rises rapidly. The electric resistance of the thin film coil pattern 69 thus increases. In this case, the alternating current supplied to the thin film coil pattern 69 continuously keeps the constant amplitude. Accordingly, as is apparent from FIG. 10, the alternating current serves to increase the voltage appearing at the thin film coil pattern 69. The amplitude value W increases from the reference amplitude value Ws. The controller circuit 76 in this manner detects a contact between the flying head slider 22 and the magnetic recording disk 14. The shrinkage amount Zs at the contact, namely when the flying height H=0, is specified. The shrinkage amount Zt is calculated for realization of the target flying height Hs.

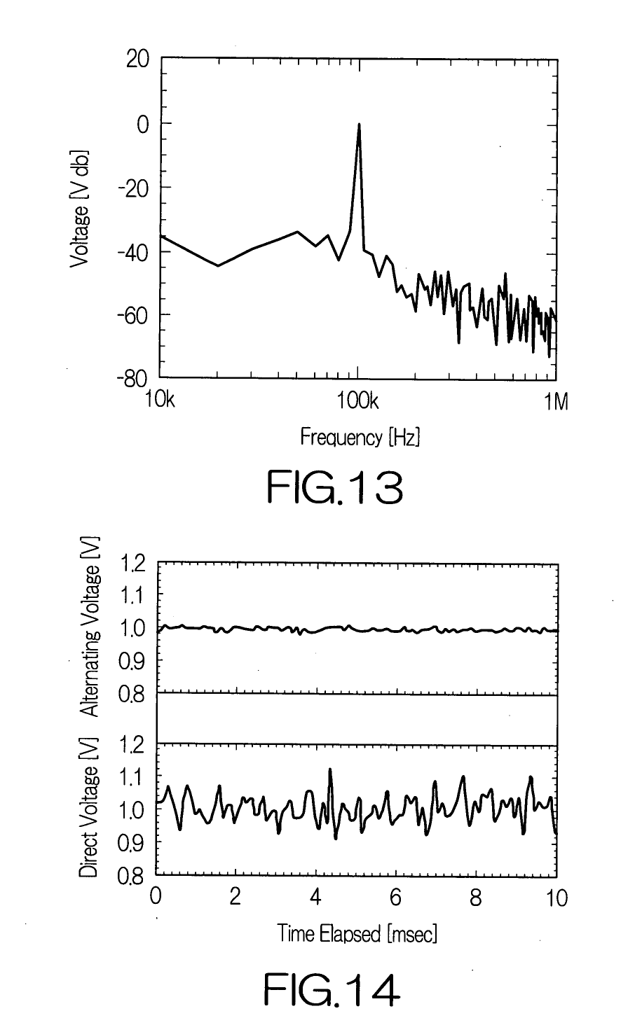

The inventors have observed difference between the aforementioned determination of contact employing the alternating voltage and the determination of contact employing the direct voltage. The inventors utilized a computer simulation for the observation. As shown in FIG. 11, the alternating voltage was set to have the amplitude of 1.0 [V] and the frequency of 100-[kHz]. The direct voltage was set to have the voltage of 1.0-[V]. Noise was superposed on the alternating voltage and the direct voltage. FIG. 12 illustrates the frequency spectrum of the noise. When the voltage waveform of the alternating voltage was subjected to the Fourier transform between 0 [msec] and 0.1 [msec], for example, the peak of the voltage appeared at the frequency of 100 [kHz], as shown in FIG. 13. The Fourier transform served to remarkably reduce the voltage level at frequencies other than the frequency of 100 [kHz]. Specifically, the voltage amplitude of the frequency of 100 [kHz] was extracted. The Fourier transform was executed for every 0.1 [msec] in the duration of 10 [msec]. Change of the voltage amplitude was in this manner observed in the alternating voltage at the frequency of 100[kHz], as shown in FIG. 14. The direct voltage was likewise observed in the duration of 10 [msec]. The average value was calculated for the direct voltage for every 0.1 [msec]. The sequence of the average values was observed. As is apparent from FIG. 14, it was confirmed that the alternating voltage is allowed to enjoy a remarkable reduction of the noise as compared with the direct voltage. If the aforementioned margin R is determined based on the amplitude value of the alternating voltage, an increase of the amplitude value resulting from contact can reliably be separated from the change of the amplitude value resulting from the noise. The margin R can be set at a small value.

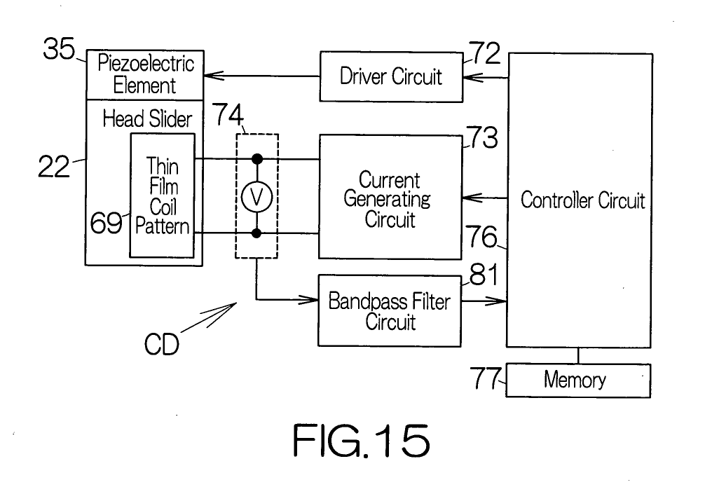

As shown in FIG. 15, a bandpass filter circuit 81 may be utilized in place of the frequency analyzing circuit 75 so as to establish the aforementioned determining apparatus CD, for example. The alternating voltage may pass through the bandpass filter circuit 81 at the frequency of f[Hz]. Like reference numerals are attached to structure and components equivalent to those of the aforementioned embodiment.

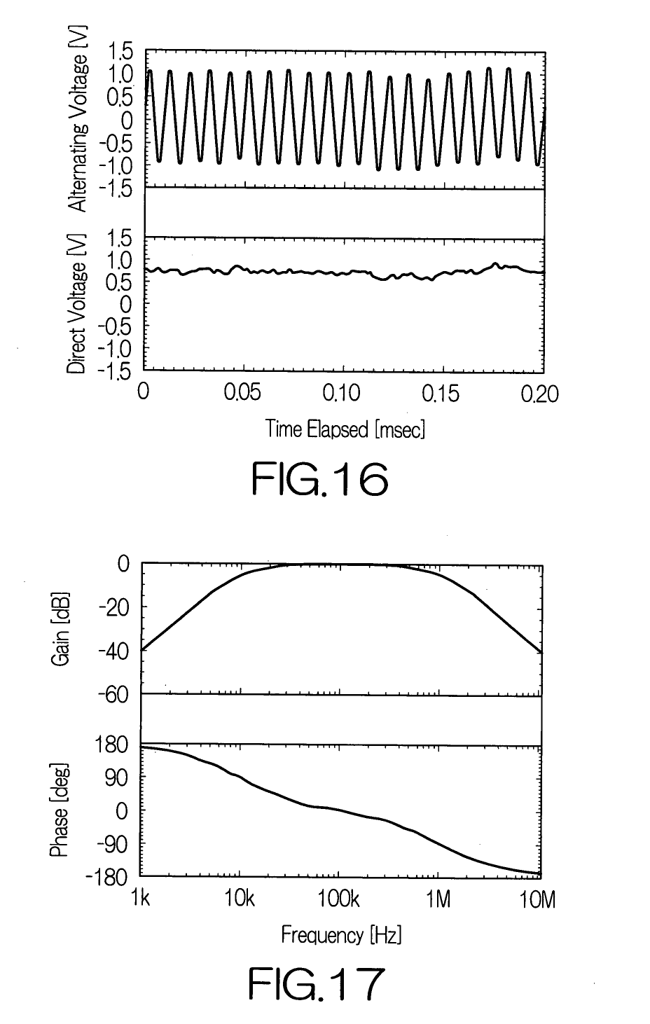

Here, the inventors have likewise observed difference between the determination of contact employing the alternating voltage and the determination of contact employing the direct voltage. The inventors utilized a computer simulation for the observation. As shown in FIG. 16, the alternating voltage was set to have the amplitude of 1.0 [V] and the frequency of 100 [kHz]. The direct voltage was set to have the voltage of 0.71 [V]. Noise was superposed on the alternating voltage and the direct voltage in the aforementioned manner. FIG. 17 illustrates the frequency characteristic of the bandpass filter circuit 81. In this case, the bandpass filter circuit 81 is designed to have the transfer function in accordance with the following expression.

$$\begin{matrix}[ Expression 1 ] & \\ \frac{{ω}_{2}^{2} {s}^{2}}{{( s + {ω}_{1} )}^{2} {( s + {ω}_{2} )}^{2}} \\ where \\ {ω}_{1} = {10}^{4} \times 2 π [ rad \text{/} s ] \\ {ω}_{2} = {10}^{6} \times 2 π [ rad \text{/} s ] & ( 1 )\end{matrix}$$

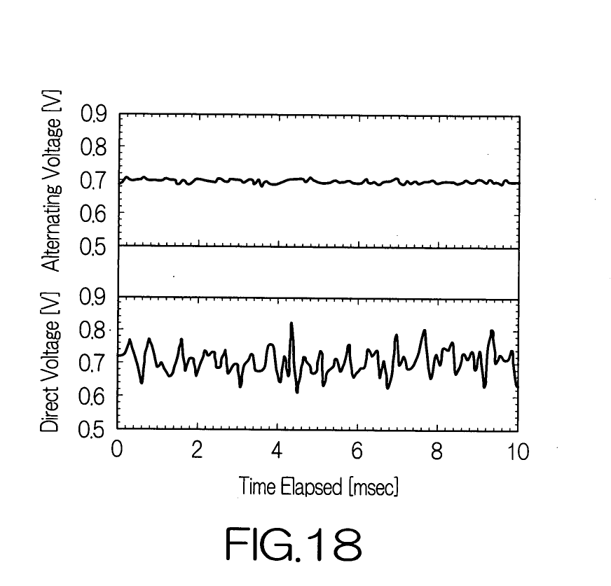

The alternating voltage was applied to the bandpass filter circuit 81. Effective voltage was calculated for every 0.1 [msec] based on the alternating voltage filtering through the bandpass filter circuit 81. As shown in FIG. 18, change of the voltage amplitude was observed in the alternating voltage at the frequency of 100 [kHz]. The direct voltage was likewise observed in the duration of 10 [msec]. The effective voltage was calculated for every 0.1 [msec]. Change of the effective voltage was specified. As is apparent from FIG. 18, it was confirmed that the alternating voltage is allowed to enjoy a remarkable reduction of the noise as compared with the direct voltage.

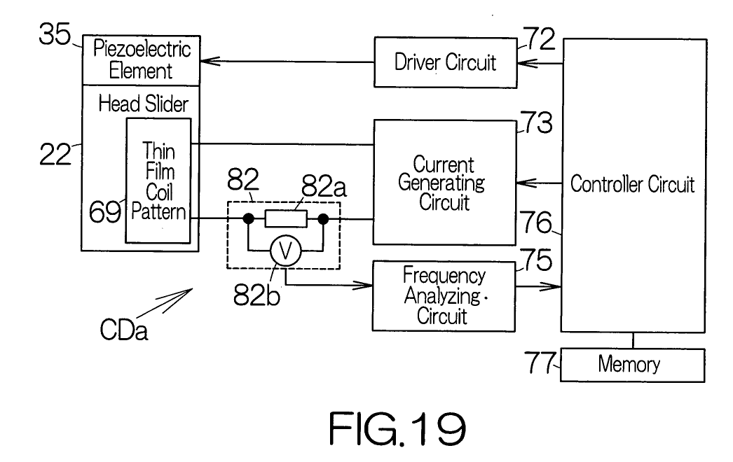

FIG. 19 illustrates a determining apparatus CDa according to a second embodiment of the present invention. The determining apparatus CDa allows the current generating circuit 73 to keep a constant amplitude of the alternating voltage in place of the aforementioned constant amplitude of the alternating current. In this case, a current measuring circuit 82 is connected to the thin film coil pattern 69 in place of the aforementioned voltage measuring circuit 74. The current measuring circuit 82 may include a resistive element 82a and a voltage measuring circuit 82b, for example. The electrical resistive element 82a is located in an electric wiring between the current generating circuit 73 and the thin film coil pattern 69. The voltage measuring circuit 82b is designed to detect the voltage of the resistive element 82a. Change in the voltage value represents change in the current value in the current measuring circuit 82. The current measuring circuit 82 thus detects the voltage waveform. In this case, the current values correspond to a sequence of indices for current according to the present invention.

The frequency analyzing circuit 75 subjects the voltage waveform to Fourier transform in every specific period. A spectrum is thus detected in the frequency analyzing circuit 75. The spectrum indicates amplitude of the alternating current at every frequency. The frequency analyzing circuit 75 extracts from the spectrum the amplitude of a component corresponding to the aforementioned frequency f. The frequency analyzing circuit 75 outputs an amplitude value signal of the current value for the specific periods. A numerical value of the current amplitude is presented in the amplitude value signal. The controller circuit 76 determines the shrinkage amount of the piezoelectric element 35 when the flying head slider 22 has contacted with the magnetic recording disk 14 based on the amplitude value signal in the same manner as described above. It should be noted that an element, such as Hall element, designed to detect magnetic field may be employed as the current measuring circuit 82. Otherwise, the frequency analyzing circuit 75 may likewise be replaced with a bandpass filter circuit in the aforementioned manner. Like reference numerals are attached to structure and components equivalent to those of the aforementioned first embodiment.

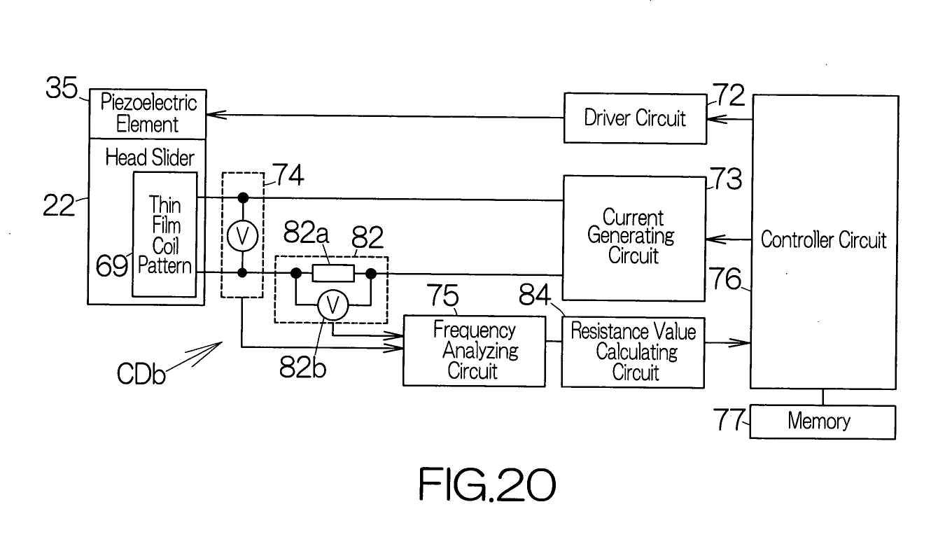

FIG. 20 illustrates a determining apparatus CDb according to a third embodiment of the present invention. The determining apparatus CDb includes the voltage measuring circuit 74 and the current measuring circuit 82 at the same time. The frequency analyzing circuit 75 subjects the voltage waveform and the current waveform to Fourier transform in every specific period. Spectra are thus detected in the frequency analyzing circuit 75. The spectrum indicates the current amplitude of the alternating current at every frequency. The spectrum indicates the voltage amplitude of the alternating voltage at every frequency. The frequency analyzing circuit 75 extracts from the spectra the amplitude of a component corresponding to the frequency f, respectively. The frequency analyzing circuit 75 outputs an amplitude value signal of the voltage value and an amplitude value signal of the current value for the specific periods. A numerical value of the voltage amplitude and a numerical value of the current amplitude are respectively presented in the amplitude value signals.

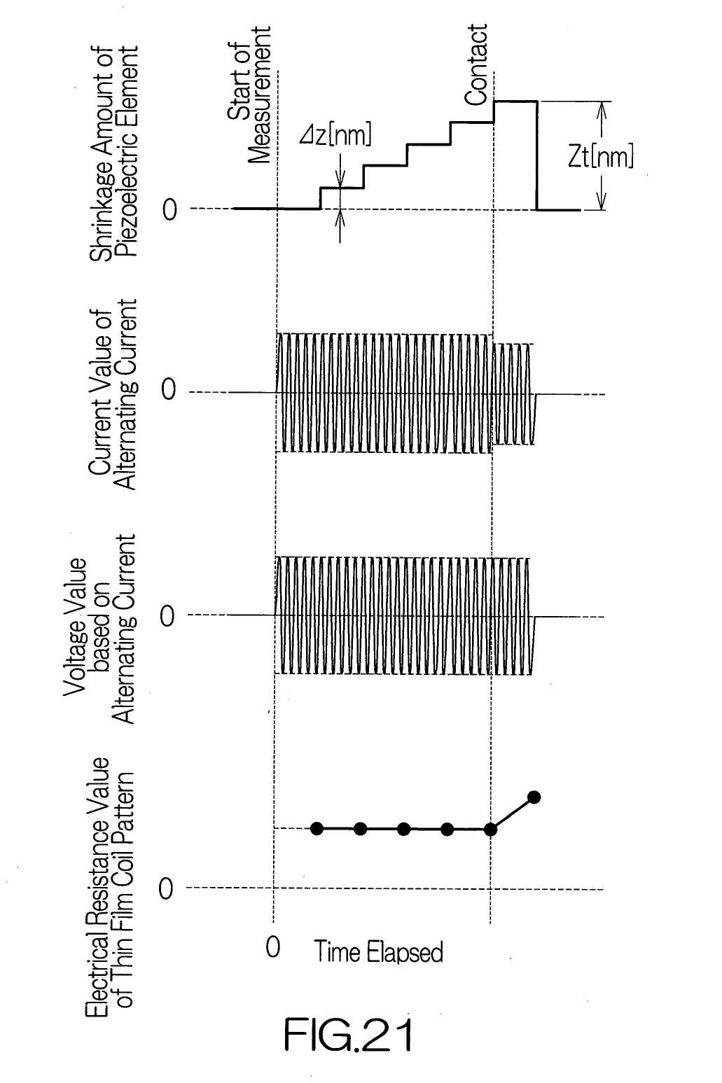

A resistance value calculating circuit 84 is connected to the frequency analyzing circuit 75. The resistance value calculating circuit 84 calculates an electrical resistance value of the thin film coil pattern 69 based on the numerical value of the voltage amplitude and the numerical value of the current amplitude presented in the amplitude value signals. A sequence of the electrical resistance value is output from the resistance value calculating circuit 84. As shown in FIG. 21, the controller circuit 76 in this manner detects a contact between the flying head slider 22 and the magnetic recording disk 14 in response to an increase in the electrical resistance in the same manner as described above. In this case, the output of the resistance value calculating circuit 84 serves as the aforementioned amplitude value signal. Like reference numerals are attached to structure and components equivalent to those of the aforementioned first and second embodiments. Otherwise, the frequency analyzing circuit 75 may likewise be replaced with the bandpass filter circuit 81.

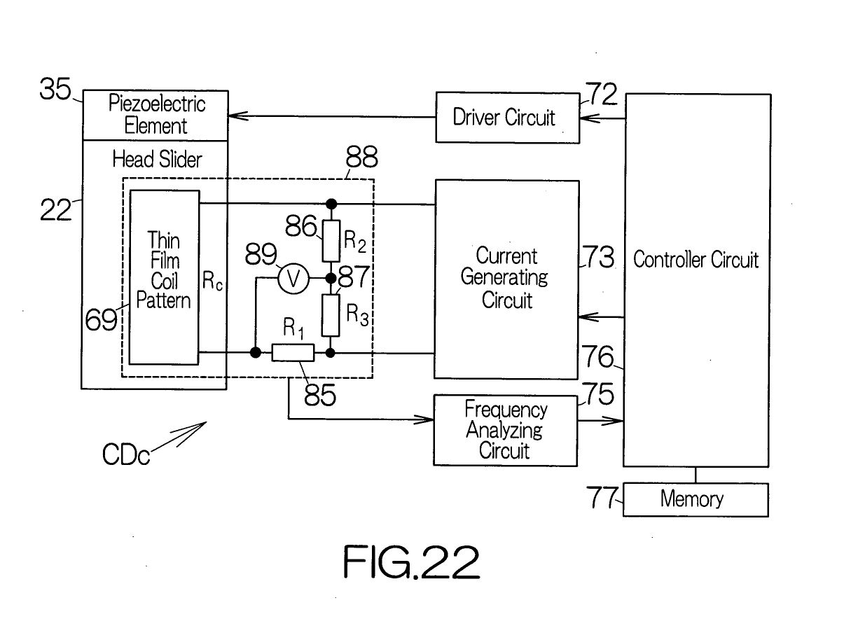

FIG. 22 illustrates a determining apparatus CDc according to a fourth embodiment of the present invention. The determining apparatus CDc includes first, second and third resistive elements 85, 86, 87, connected to the thin film coil pattern 69, in place of the voltage measuring circuit 74 and the current measuring circuit 82. The first resistive element 85 is connected to the thin film coil pattern 69 in series. The second and third resistive elements 86, 87 are connected to the first resistive element 85 and the thin film coil pattern 69 in parallel, while the second and third resistive elements 86, 87 are connected to each other in series. The thin film coil pattern 69 and the first to third resistive elements 85, 86, 87 in combination establish a bridge circuit 88. A wiring is established between the thin film coil pattern 69 and the first resistive element 85. A wiring is also established between the second and third resistive elements 86, 87. A voltage measuring circuit 89 is connected between the wirings. In this case, the following relationship is established for the resistance value R₁, of the first resistive element, the resistance value R₂ of the second resistive element 86, the resistance value R₃ of the third resistive element and the resistance value R_{c} of the thin film coil pattern 69.

### [Expression 2]

Rc:R₁=R₂:R₃ (2)

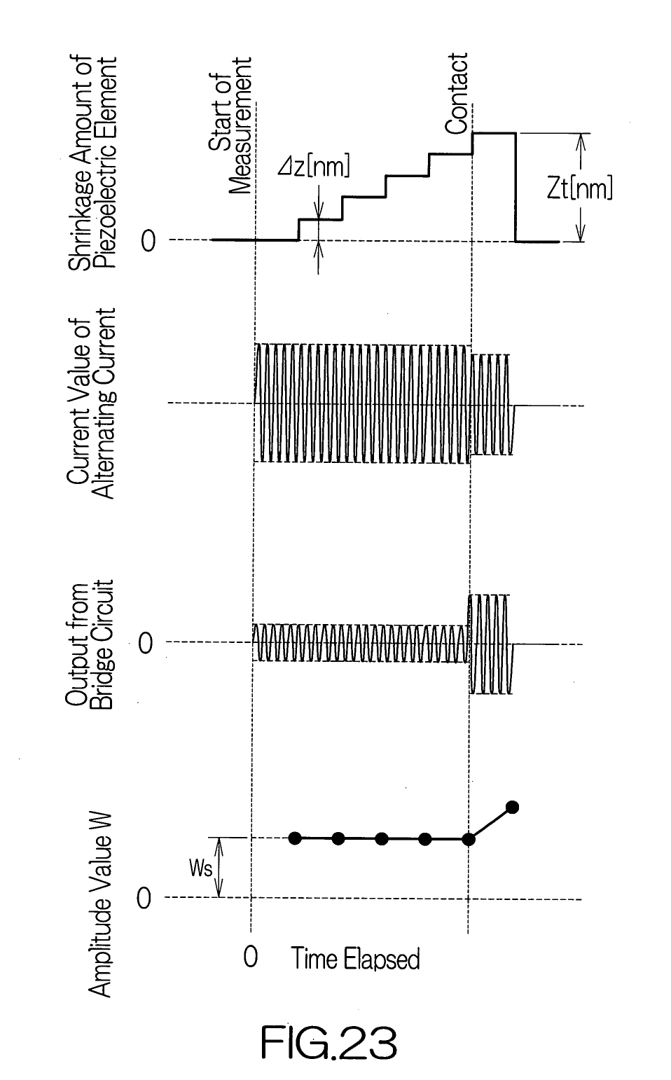

When the alternating current is supplied to the thin film coil pattern 69 from the current generating circuit 73 in setting the target flying height Hs, the voltage measuring circuit 89 detects a small reference amplitude value Ws, as shown in FIG. 23. When the resistance value R_{c} of the thin film coil pattern 69 rapidly increases in response to the contact, the voltage measuring circuit 89 detects a larger amplitude value W. The amplitude value W is thus amplified. A contact is in this manner reliably determined. The output of the voltage measuring circuit 89 corresponds to a sequence of indices for current according to the present invention. The controller circuit 76 may determine a contact between the flying head slider 22 and the magnetic recording disk 14 in accordance with the same procedures as described above in setting the target flying height Hs. Here, the output of the bridge circuit 88 serves as the aforementioned amplitude value signal. Like reference numerals are attached to structure and components equivalent to those of the aforementioned first to third embodiments. The frequency analyzing circuit 75 may likewise be replaced with the bandpass filter circuit 81 in the aforementioned manner.

The piezoelectric element 35 is fixed to the fixation plate 32 of the flexure 31 as described above. Alternatively, the piezoelectric element 35 may be fixed to the flying head slider 22, for example. In addition, the actuator employing the piezoelectric element 35 in the aforementioned manner may be replaced with an actuator utilizing a thermal expansion, an electrostatic force, an electromagnetic force, or the like.

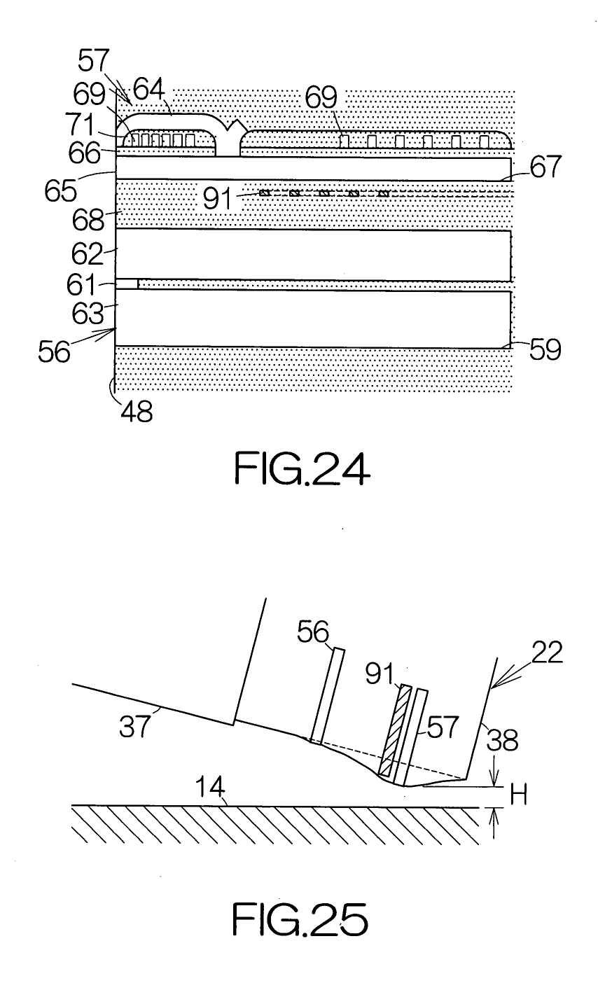

As shown in FIG. 24, a heater or heating wire 91 may be incorporated in the electromagnetic transducer 39 on the flying head slider 22. The heating wire 91 is embedded in the non-magnetic layer 68 at a location adjacent to the write head element 57. The heating wire 91 may extend along an imaginary plane perpendicular to the air bearing surface 48, for example. The thin film coil pattern 69 has a relatively large coefficient of thermal expansion, so that the thin film coil pattern 69 expands when electric power is supplied to the heating wire 91. As a result, as shown in FIG. 25, the front end of the thin film coil pattern 69 swells at the surface of the head protection film 38. The CPP structure read head element 56 and the write head element 57 thus displace toward the magnetic recording disk 14. A so-called heat actuator is established. The flying height H of the write head element 57 is determined according to the protrusion amount of the write head element 57, for example. In this case, the aforementioned piezoelectric element 35 may be omitted.

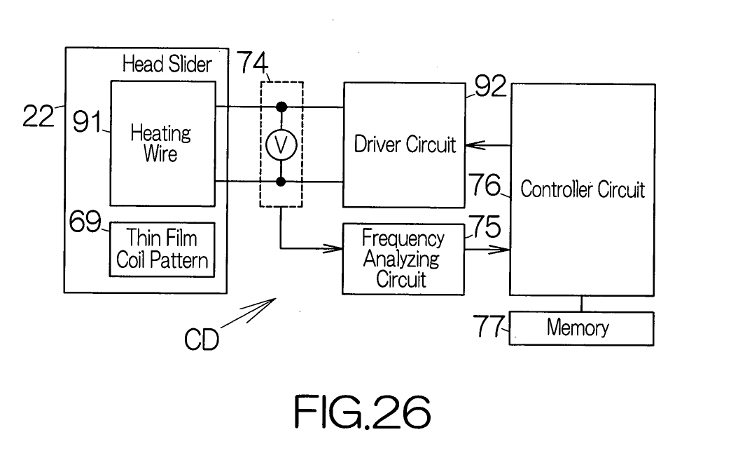

As shown in FIG. 26, the determining apparatus CD according to the first embodiment of the present invention is connected to the heating wire 91. A driver circuit 92 serves as the current generating circuit 73 in the determining apparatus CD. The driver circuit 92 is connected to the heating wire 91. The driver circuit 92 outputs the alternating current having a specific frequency f[Hz]. The specific frequency f may be set equal to or higher than 10 [kHz] approximately, for example. The frequency f is preferably set equal to or higher than l[MHz] approximately. Here, the driver circuit 92 keeps the amplitude of the alternating current constant.

In this case, the following expression is established between the power consumption W of the heating wire 91 and the displacement amount Z.

### [Expression 3]

Z=CₕW (3)

At the same time, the following expression is established between the power consumption W, the effective voltage V and the effective current I.

$$\begin{matrix}[ Expression 4 ] & \\ W = VI = \frac{{V}^{2}}{{R}_{h}} = {I}^{2} {R}_{h} & ( 4 )\end{matrix}$$

Here, the constant Cₕ indicates the actuator coefficient [nm/W] of the actuator. The constant Rₕ indicates the electrical resistance [Ω] of the heating wire 91. In this case, the following expression may be established between the displacement amount ΔZ[nm] of the actuator and the power consumption p[W].

$$\begin{matrix}[ Expression 5 ] & \\ p = \frac{Δ Z}{{C}_{h}} & ( 5 )\end{matrix}$$

The effective current i[A] in the heating wire 91 may be set as follows.

$$\begin{matrix}[ Expression 6 ] & \\ i = \sqrt{\frac{p}{{R}_{h}}} = \sqrt{\frac{Δ Z}{{c}_{h} {R}_{h}}} & ( 6 )\end{matrix}$$

The aforementioned voltage measuring circuit 74 is connected to the heating wire 91. The frequency analyzing circuit 75 is connected to the voltage measuring circuit 74 in the same manner as described above. The controller circuit 76 is connected to the frequency analyzing circuit 75 in the same manner as described above. The controller circuit 76 executes the procedures in the same manner as described above. Like reference numerals are attached to structure and components equivalent to those of the aforementioned embodiments.

Now, assume that a reference value H(=0) of the flying height is determined. First of all, the displacement amount Zt of the heat actuator is set at zero [nm]. Namely, the driver circuit 92 suspends supply of the alternating current.

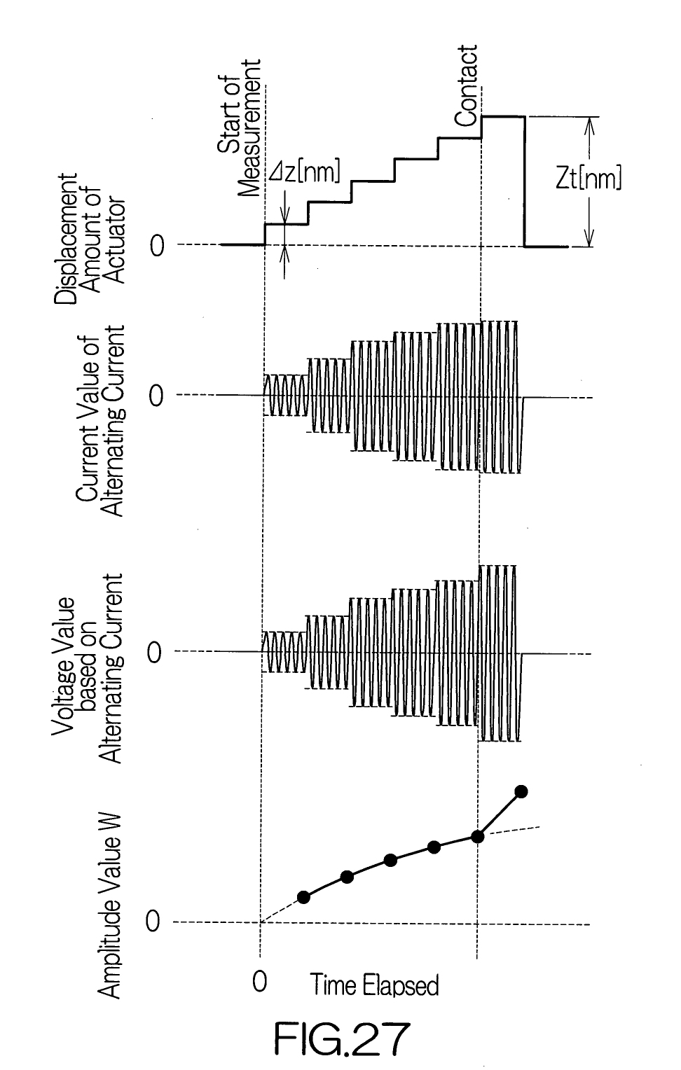

Subsequently, the controller circuit 76 outputs the instructions for the supply of the alternating current in the same manner as described above. The alternating current is supplied to the heating wire 91 from the driver circuit 92. As shown in FIG. 27, the alternating current keeps a constant amplitude. The controller circuit 76 receives the amplitude value signal from the frequency analyzing circuit 75 in response to the supply of the alternating current.

The heating wire 91 generates heat in response to the supply of the alternating current. The heat causes the heating wire 91 to expand. The write head element 57 swells on the surface of the head protection film 38 by a predetermined value ΔZ[nm]. As shown in FIG. 27, the controller circuit 76 then causes the write head element 57 to further rise by the predetermined value ΔZ at predetermined time intervals. In this case, the effective current i[A] of the alternating current is established as follows.

$$\begin{matrix}[ Expression 7 ] & \\ i = \sqrt{\frac{p \cdot N}{{R}_{h}}} = \sqrt{\frac{Δ Z \cdot N}{{c}_{h} {R}_{h}}} & ( 7 )\end{matrix}$$

Here, the variable N indicates the time of the increment of the predetermined value ΔZ. The following relationship is established between the displacement amount Zt and the effective voltage v.

$$\begin{matrix}[ Expression 8 ] & \\ v = \sqrt{( p \cdot N ) {R}_{h}} = \sqrt{\frac{( Δ Z \cdot N ) {R}_{h}}{{c}_{h}}} & ( 8 )\end{matrix}$$

As long as the displacement amount Zt of the actuator repeatedly increments by the predetermined value ΔZ at the predetermined time intervals, the amplitude of the voltage measured at the frequency analyzing circuit 75 rises in proportion to the square root of the displacement amount Zt. A quadratic curve is established for the amplitude of the voltage. In the case where the amplitude value W deviates from the quadratic curve, the controller circuit 76 determines the contact of the flying head slider 22 with the magnetic recording disk 14.

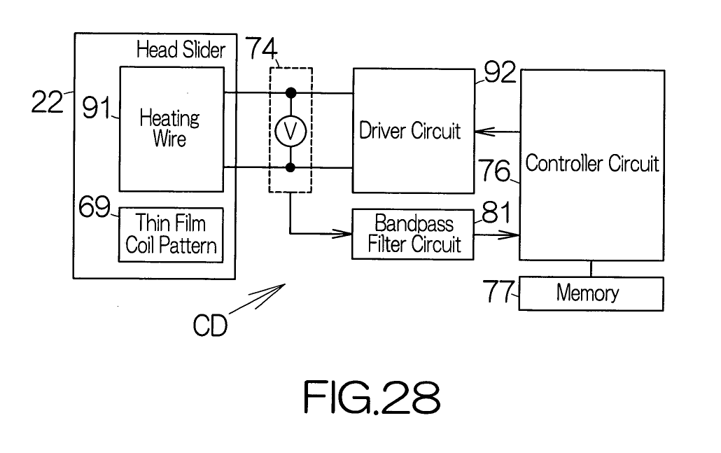

Here, the aforementioned bandpass filter circuit 81 may be utilized in place of the frequency analyzing circuit 75 in the determining apparatus CD, as shown in FIG. 28, for example. The alternating current may pass through the bandpass filter circuit 81 at a specific frequency f[Hz]. Other structure and components may be employed in the same manner as described above.

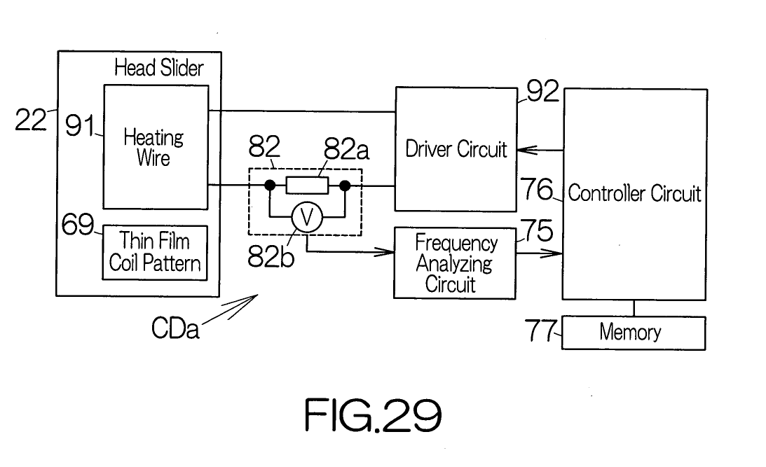

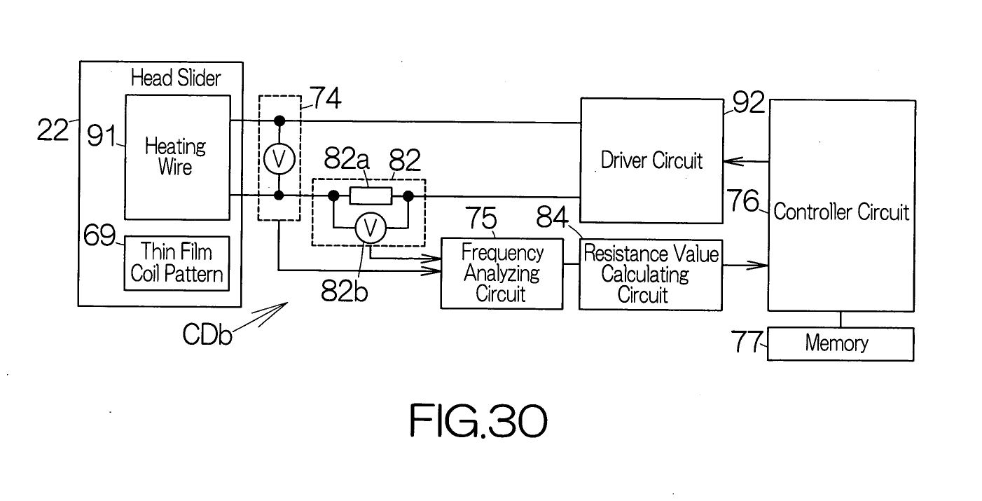

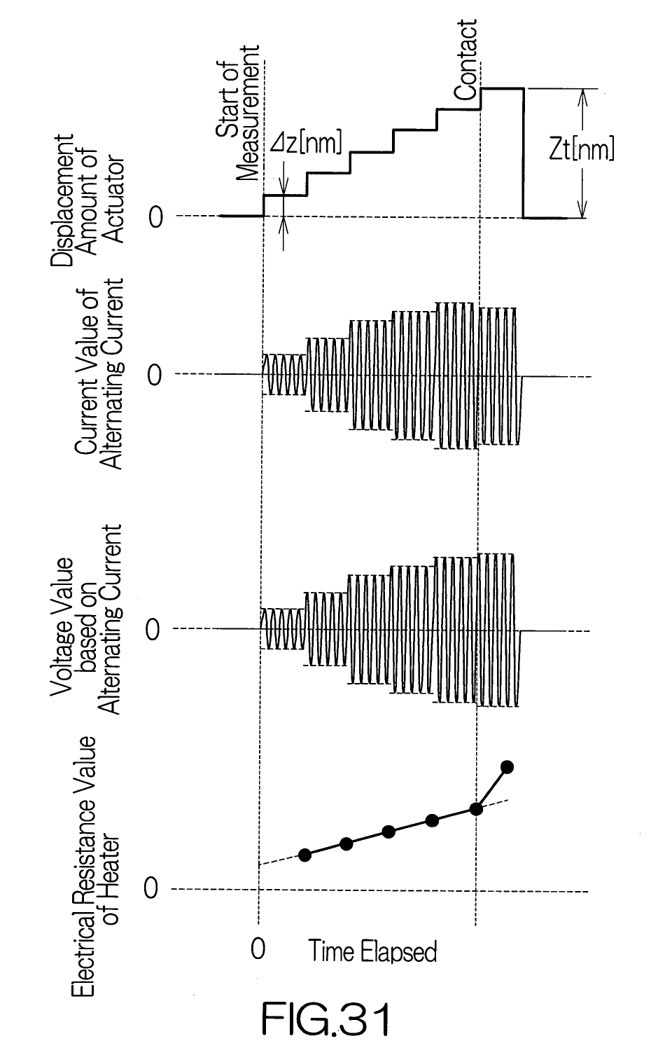

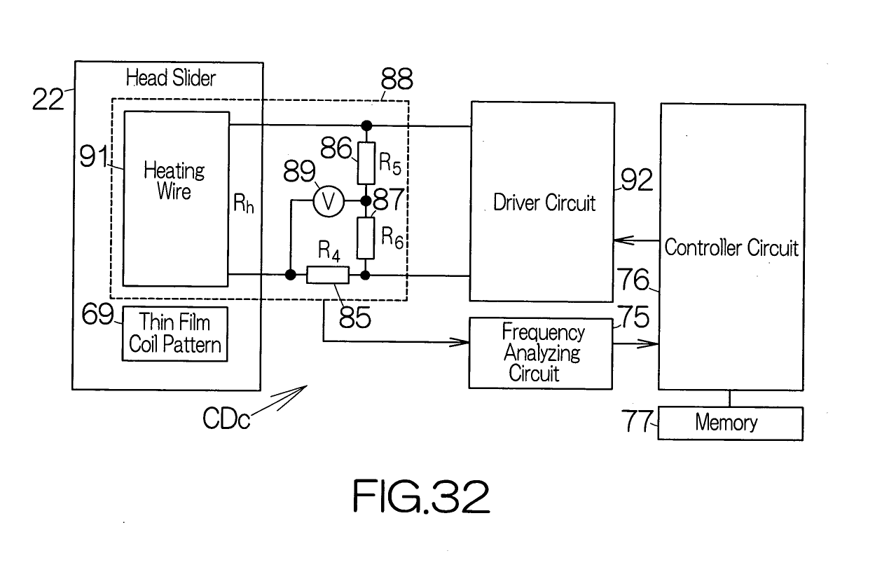

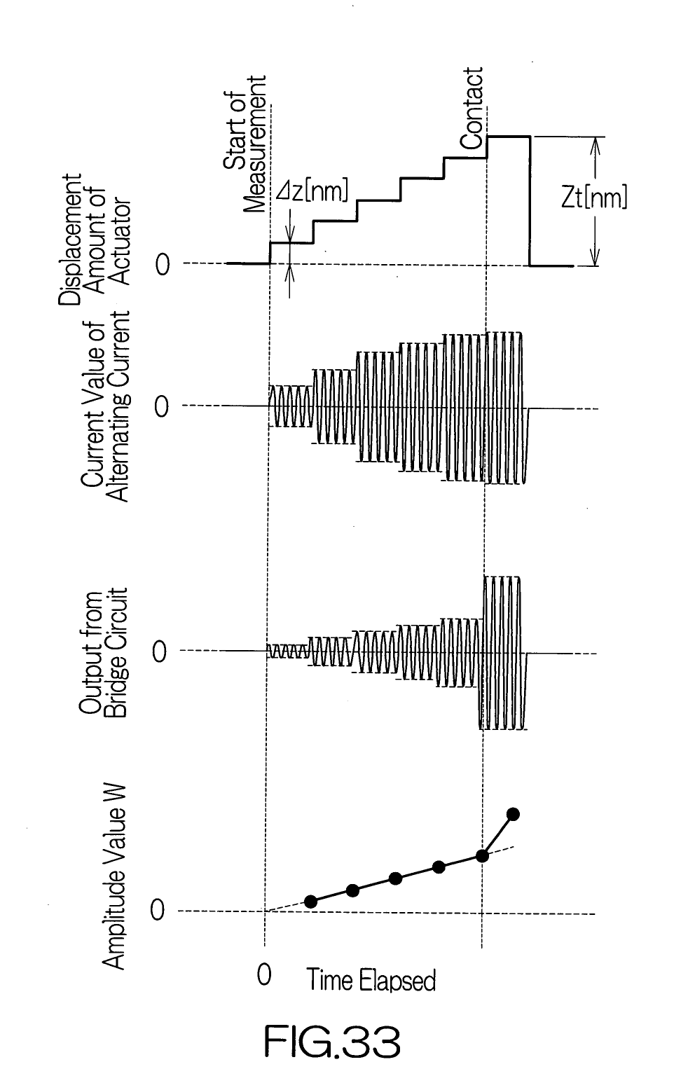

As shown in FIG. 29, the determining apparatus CDa according to the second embodiment of the present invention may be connected to the heating wire 91 in place of the determining apparatus CD. Alternatively, the determining apparatus CDb according to the third embodiment of the present invention may be connected to the heating wire 91 in place of the determining apparatus CD or CDa, for example, as shown in FIG. 30. In this case, the controller circuit 76 is allowed to determine the contact of the flying head slider 22 with the magnetic recording disk 14 based on the increase of the electrical resistance value, as shown in FIG. 31. In addition, the determining apparatus CDc according to the fourth embodiment of the present invention may be connected to the heating wire 91 in place of the determining apparatus CD, CDa or CDb, for example, as shown in FIG. 32. In this case, the following relationship is established for the resistance value R₄ of the first resistive element 85, the resistance value R₅ of the second resistive element 86, the resistance value R₆ of the third resistive element 87 and the resistance value Rₕ of the heating wire 91.

### [Expression 9]

Rₕ:R₄=R₅:R₆ (9)

In this case, the controller circuit 76 is allowed to determine the contact of the flying head slider 22 with the magnetic recording disk 14 based on the amplified amplitude value W, as shown in FIG. 33. In any case, like reference numerals are attached to structure and components equivalent to those of the aforementioned embodiments. In any case, the frequency analyzing circuit 75 may be replaced with the bandpass filter circuit 81 in the same manner as described above.

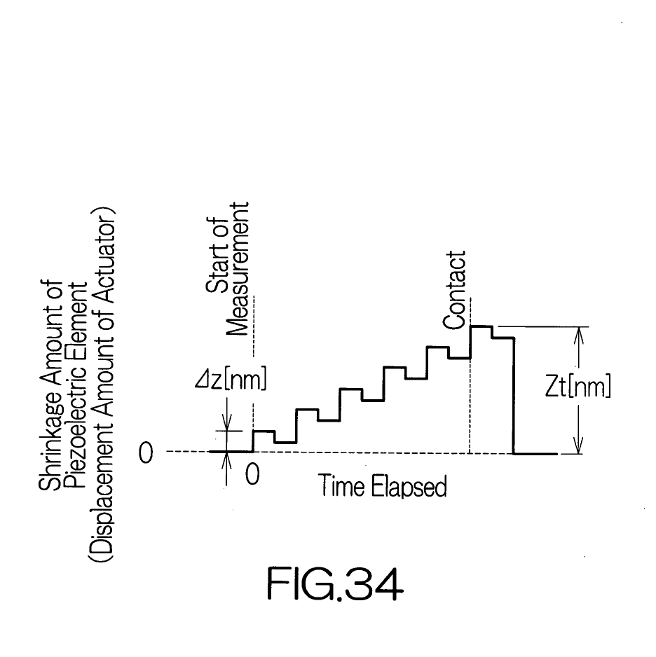

As shown in FIG. 34, increment and decrement may alternately be repeated to increase the shrinkage amount Zt of the piezoelectric element 35 or the displacement amount Zt of the heat actuator by the predetermined value ΔZ, for example. The duration of the decrement may be set based on the processing time of the frequency analyzing circuit 75, for example. The intermittent decrement of the shrinkage amount Zt or the displacement amount Zt enables contact between the flying head slider 22 and the magnetic recording disk 14 in a reduced time period. The electromagnetic transducer 39 is thus allowed to enjoy a reduced influence of wear.

What is claimed is:

1. An apparatus for determining contact of a head slider, comprising:
an AC power source connected to a write coil mounted on the head slider, the AC power source outputting an alternating current having a specific frequency;
a measuring circuit measuring a sequence of indices for current supplied to the write coil; and
a detecting circuit connected to the measuring circuit, the detecting circuit detecting contact between the head slider and a storage medium based on a change in amplitude of the sequence appearing at the specific frequency.

2. The apparatus according to claim 1, wherein the AC power source keeps amplitude of the alternating current constant, and the measuring circuit measures voltage appearing at the write coil based on the alternating current.

3. The apparatus according to claim 1, wherein the AC power source keeps amplitude of voltage, appearing at the AC power source, constant, and the measuring circuit measures a current value of the alternating current.

4. The apparatus according to claim 1, wherein the measuring circuit measures a current value of the alternating current and a voltage value of voltage appearing at the write coil based on the alternating current, and the detecting circuit calculates a sequence of an electrical resistance value based on a sequence of the current value and a sequence of the voltage value.

5. The apparatus according to claim 1, further comprising an electrical resistive element connected to the write coil, the electrical resistive element establishing a bridge circuit in cooperation with the write coil, wherein
the detecting circuit specifies the change in the amplitude of the sequence based on an output from the bridge circuit.

6. A method of determining contact of a head slider, comprising:
applying an alternating current having a specific frequency to a write coil mounted on the head slider;
measuring a sequence of indices for current supplied to the write coil; and
detecting a change in amplitude of the sequence appearing at the specific frequency while the write coil gets closer to a storage medium.

7. The method according to claim 6, further comprising:
keeping amplitude of the alternating current constant in application of the alternating current; and
measuring voltage appearing at the write coil based on the alternating current for measurement of the sequence.

8. The method according to claim 6, further comprising:
keeping amplitude of voltage, appearing at the AC power source, constant for application of the alternating current; and
measuring a current value of the alternating current for measurement of the sequence.

9. The method according to claim 6, further comprising:
measuring a current value of the alternating current and a voltage value of voltage appearing at the write coil based on the alternating current for measurement of the sequence; and
calculating a sequence of an electrical resistance value based on a sequence of the current value and a sequence of the voltage value for detection of the change in the amplitude.

10. An apparatus for determining contact of a head slider, comprising:
an AC power source connected to a heater mounted the head slider, the AC power source outputting an alternating current having a specific frequency;
a measuring circuit measuring a sequence of indices for current supplied to the heater; and
a detecting circuit connected to the measuring circuit, the detecting circuit detecting contact between the head slider and a storage medium based on a change in amplitude of the sequence appearing at the specific frequency.

11. The apparatus according to claim 10, wherein the AC power source keeps amplitude of the alternating current constant, and the measuring circuit measures voltage appearing at the heater based on the alternating current.

12. The apparatus according to claim 10, wherein the AC power source keeps amplitude of voltage, appearing at the AC power source, constant, and the measuring circuit measures a current value of the alternating current.

13. The apparatus according to claim 10, wherein the measuring circuit measures a current value of the alternating current and a voltage value of voltage appearing at the heater based on the alternating current, and the detecting circuit calculates a sequence of an electrical resistance value based on a sequence of the current value and a sequence of the voltage value.

14. The apparatus according to claim 10, further comprising an electrical resistive element connected to the heater, the electrical resistive element establishing a bridge circuit in cooperation with the heater, wherein
the detecting circuit specifies the change in the amplitude of the sequence based on an output from the bridge circuit.

15. A method of determining contact of a head slider, comprising:
applying an alternating current having a specific frequency to a heater mounted on the head slider, the heater related to a write coil;
measuring a sequence of indices for current supplied to the heater; and
detecting a change in amplitude of the sequence appearing at the specific frequency while the write coil gets closer to a storage medium.

16. The method according to claim 15, further comprising:
keeping amplitude of the alternating current constant for application of the alternating current; and
measuring voltage appearing at the heater based on the alternating current for measurement of the sequence.

17. The method according to claim 15, further comprising:
keeping amplitude of voltage, appearing at the AC power source, constant for application of the alternating current; and
measuring a current value of the alternating current for measurement of the sequence.

18. The method according to claim 15, further comprising:
measuring a current value of the alternating current and a voltage value of voltage appearing at the heater based on the alternating current; and
calculating a sequence of an electrical resistance value based on a sequence of the current value and a sequence of the voltage value for detection of the change in the amplitude.
